(19) United States
(12) Patent Application Publication
(10) Pub. No.: US 2005/0258099 A1
(43) Pub. Date: Nov. 24, 2005

(54) Machine and method to derive energy from through diffusion and/or osmotic pressure

(76) Inventor: Ian Douglas Winters, Clarksville, TN (US)

Correspondence Address: David D. Winters;Suite 2277-C, 237 Wilma Rudolph Blvd., Clarksville, TN, 37040-5898, US

(21) Appl. No.: 11/124,840

(22) Filed: May 9, 2005

Related U.S. Application Data
(60) Provisional application No. 60/572,062, filed on May 18, 2004.

(51) Int. Cl. B01D 61/06

(52) U.S. Cl. 210/637; 210/321.66; 210/644; 210/321.65

(57) ABSTRACT

A machine for and method of exploiting diffusion and osmotic pressure to generate linear motion in a fluid and derive energy from it.

### CROSS REFERENCE TO RELATED APPLICATIONS

This application claims benefit of U.S. Provisional Patent Application Ser. No. 60/572,062 filed May 18, 2004.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

1. Field of Invention

This invention relates generally to the fields of chemistry and fluid flow mechanics and more specifically to a machine and method to derive energy through diffusion and/or osmotic pressure.

2. History

Certain previously known technology such as by Jellinek (U.S. Pat. No. 3,978,344) and Weingarten (U.S. Pat. No. 3,587,227) that exploit osmotic pressure as an energy source require constant feed sources of fresh and saline water, or, more generally solute and solvent replenishment. They make no provision for reconditioning their working fluids for re-use, and therefore must be located near virtually inexhaustible sources of fresh and saline water or other solvent and solute.

Another previously known osmosis energy generation technology by Loeb (U.S. Pat. No. 4,193,267) uses a heat engine model, requiring a heat source and/or a heat sink and significant hydraulic pressures and pressure differentials to operate.

### OBJECT OF INVENTION

One object of this invention is to generate and extract energy using physical and chemical properties of diffusion and osmosis.

Another object of this invention is to generate and extract energy using physical and chemical properties of diffusion and osmosis while avoiding the need for fresh solvent, solute, or solution replenishment external to the system.

Another object of this invention is to accomplish energy extraction from diffusion and osmotic pressure at near ambient atmospheric temperatures and pressures.

Other objects and advantages of the present invention will become apparent from the following descriptions, taken in connection with the accompanying drawings, wherein, by way of illustration and example, embodiments of the present invention are disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a cross sectional view of the invention, in a preferred mode, with the top open.

FIG. 2 is a cross sectional view of the invention, in an alternate preferred mode, with the top portion closed to the external atmosphere.

### BRIEF DESCRIPTION OF THE DRAWINGS

### List of Parts

Downward inlet portion affixed with a semi-permeable membrane 10

Submerged portion of solution container 15

Inlet semi-permeable membrane 20

Closed sump 30

Essentially pure sump solvent 40

Downward outlet portion equipped with semi-permeable membrane 50

Outlet semi-permeable membrane 60

Third portion 70

Solution of solvent and solute (water and starch) 80

Re-purified solvent 85

Paddle wheel 90

Turbine 95

Inverted “Y”-shaped solution container 100

Vent Opening 110

Vent Seal 120

Agitator 130

Servo unit 135

Inward flow of solvent 140

Outward flow of solvent 145

Intersection point 155

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

This invention is based on a process of diffusion and osmotic pressure and a means of drawing energy from fluid flow generated by them. Diffusion is the movement of chemicals in a system that is not in equilibrium (i.e. a system that has a chemical gradient) as they seek to establish equilibrium. These chemicals must either be gaseous, or in solution, and either have no attraction toward their own kind, or attraction to each other greater than to their own kind, otherwise the chemicals will remain separate, like oil and water. Osmosis is a particular type of diffusion that specifically describes solvent diffusing across a semi-permeable membrane to establish equilibrium.

In the herein taught technology, the forces of diffusion and osmosis are harnessed via semi-permeable membranes. A semi-permeable membrane is a membrane that allows some molecules to pass through it, but will not allow others to pass through it. What will or will not pass may be determined or effected by molecule size, electrical charge, or some other factor.

An example of this phenomenon may be found in the walls of living cells. The cell wall is a semi-permeable membrane that will allow solvent (water) but not solute (salt) to pass through. This phenomenon explains why when a living cell is placed in a solution containing a higher concentration of salt than the cell itself, the cell will shrivel and shrink (hypertension) as the rate of water leaving the cell exceeds the rate of water entering the cell until equilibrium is established.

Conversely, if the solution has a lower concentration of salt, the cell will swell (become turgid) as the rate of water entering exceeds the rate of water exiting. If the salt in surrounding solution were of sufficiently low concentration, the cell would ultimately explode as the external and internal solutions would never reach equilibrium.

Osmotic pressure can be created through this phenomenon by exploiting the affinity of strong solutions to establish equilibrium with weak solutions across a semi-permeable membrane. The degree of osmotic pressure created is affected by, among other things, the concentration of the solution, the type of chemical(s) used, the molecular weights, the vapor pressure over the column, and the type of membrane(s) used. This osmotic pressure is here used to draw a column of water solvent up a tube, against the force of gravity, thereby creating potential energy which is then extracted by letting the water pour downward over the blades of a turbine.

In the process, and before the energy is extracted, the solvent is, by intervention of an outlet permeable membrane, reconditioned for recirculation. The system, as taught herein, requires no external heat source, external heat sink, external solvent source, external solute source, or external solution source.

### DETAILED DESCRIPTION

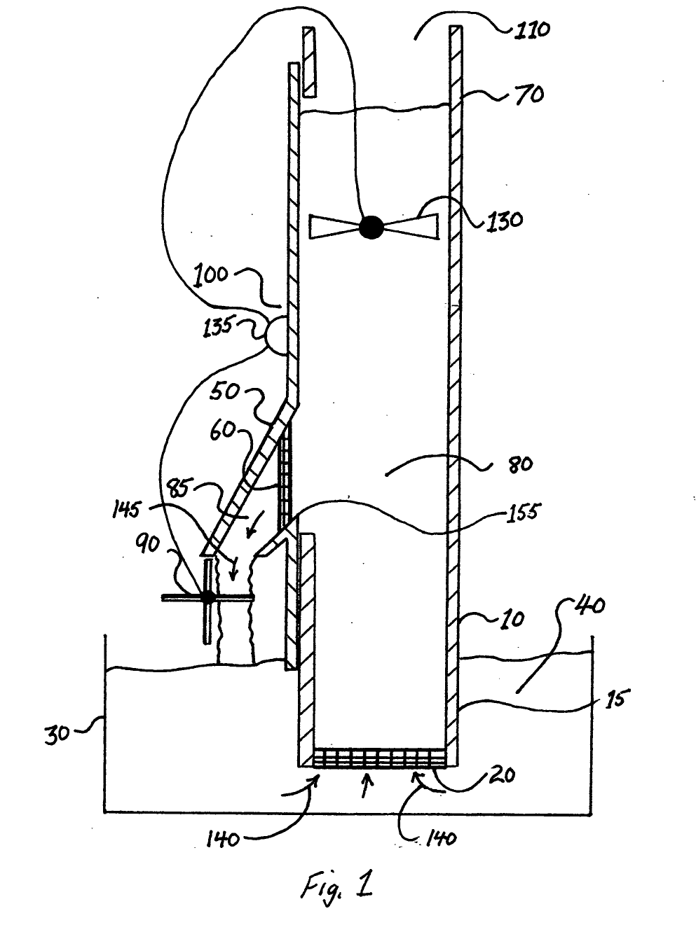

Referring to FIG. 1, in one preferred mode, this invention comprises a, generally, upside down, “Y”-shaped solution container (100). The “Y”-shaped solution container (100) has an inlet semi-permeable membrane (20) incorporated into one portion which is submerged (15) in a sump (30) containing a solvent (40) comprising essentially pure water.

Within or on a downward outlet portion (50) is placed an outlet semipermeable membrane (60) that has a higher affinity for water than does the inlet semi-permeable membrane (20) that covers the inlet submerged portion (15). This downward outlet portion (50) of the “Y” is so positioned that any liquid flowing from it (85) will ultimately flow back into the same sump (30) in which the inlet portion (15) is submerged, and from which the solvent water (40) is drawn.

The third portion (70) pointing upward is left open to atmosphere. This configuration feature tends to prevent gas pressure build up in the top of the solution container.

The inlet downward portion (10) and submerged portion (15) is filled with a solution of water solvent and starch solute (80). The starch molecules in this solution will not pass through either the inlet (20) or outlet (60) semi-permeable membrane, but water solvent (40) can pass, and will be drawn up from the sump (30) into the solution container (100) by the action of diffusion.

In this configuration, essentially pure water solvent (40) from the sump (30) is drawn by the starch and water solution (80) up into the submerged portion (15), passing through the submerged semi-permeable membrane (20). As the water solvent (40) is drawn upward, it fills up through the inlet portion (10), until it overflows at the intersection point (155) of the outlet downward portion (50) of the “Y,” where it encounters the outlet semi-permeable membrane (60).

Since this outlet membrane (60) will not permit the starch solute molecules to pass, but will allow water solvent to pass and has a higher affinity for water than does the inlet membrane (20), gravity, diffusion, and osmotic pressure impel the water solvent to separate from the solution (80) out through the outlet membrane (60). This leaves the starch solute behind in the solution (80). The re-purified water solvent (85) pours back into the sump (30) from whence it came, mixing with the solvent water (40) in the sump (30) and the cycle repeats.

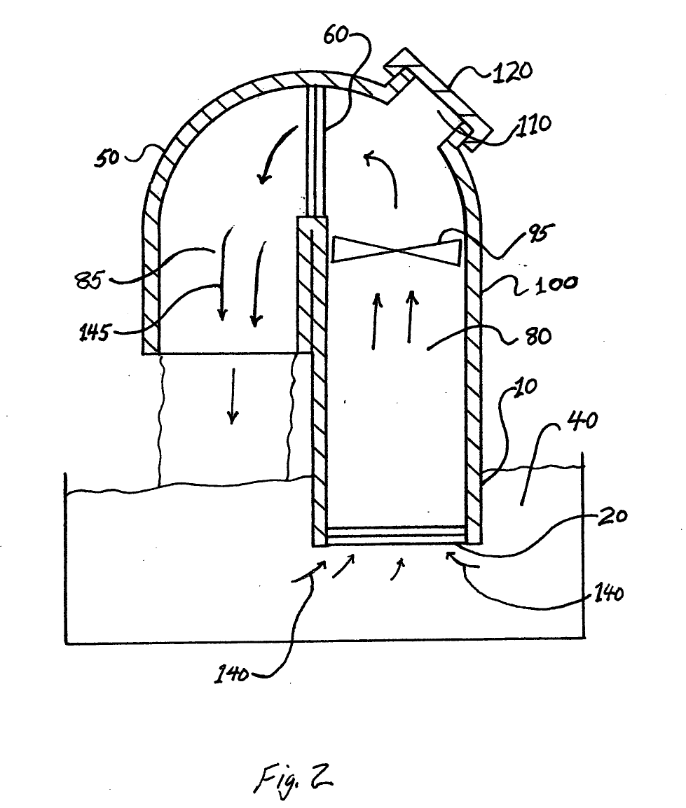

Referring now to FIG. 1 and FIG. 2, mechanical energy may be drawn from the inlet flow (140) of the water solvent as it enters the inlet portion (10), flows through the solution container (100), or flows out of the outlet portion (50). For, example, a small turbine or paddle wheel (90), as in FIG. 1, may be placed in or below the flow such that the falling liquid causes it to spin, or, it may be situated in the midst of the solution container (100), as in FIG. 2, such that flow through the container (100) will move the blades of the turbine (95).

Referring, now, to FIG. 1, with the top of the container open (110), the level of the solvent column will rise as solvent is drawn in through the inlet semi-permeable membrane (20). The column will continue to rise until equilibrium is achieved between the inward flow of solvent (140) through the inlet semi-permeable membrane (20), and the outward flow of solvent through the outlet semi-permeable membrane (60). This outward flow (145) is impelled both by gravity and by the pressure head created by the solution column in the solution container (100).

In such a configuration, the flow rate may be conveniently varied by adjusting the height of the outlet membrane (60) relative to the solution column. The lower the outlet membrane (60) is, relative to the solution column, the higher the eventual pressure head, and the higher the equilibrium flow rate. This is also particularly convenient for adjusting the system in response to variations in performance due to changes in solution concentrate, ambient pressure, or temperature, or due to changes in, or degradation of, the semi-permeable membranes (60) and (20). Under such circumstances, should the system flow experience excursions outside nominal parameters, the outlet membrane (60) location may be adjusted upward or downward to return flow to the preferred rate.

Referring to FIG. 2, in an alternative mode, the vent opening (110) may be closed or be covered with a seal (120) thus forestalling evaporation, but making the system more subject to vapor or fluid pressure build-up above the liquid column. At the same time, however, removing the gases and closing off the vent opening (110) allows the interior osmotic pressure to more compactly assist in forcing solvent through the outlet semi-permeable membrane and out of the solvent container.

Referring again to FIG. 1, an agitator (130) may be introduced that preferably draws its energy from the fluid flow. The purpose of this agitator (130) is to assist in maintaining homogeneity of the solution (80). In this depiction, an agitator (130), resembling a pin-wheel, is linked to the power turbine (90) by a simple servo mechanism (135).

Once the unit begins operation, fluid flow (140) and (145) increases until a state of flow and pressure equilibrium are reached between the inlet membrane (20) and the outlet membrane (60), and continues until one or both membranes become so degraded as to no longer support the necessary diffusion and osmotic action. The system as taught herein requires no heat source, heat sink, external solvent source or external solute source.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A machine for generating and extracting energy from sources that include properties of diffusion and osmosis, comprising;
a solution container containing solvent and solute and having;
at least one inlet portion of the container affixed with at least one inlet semi-permeable membrane, said membrane having an affinity for the solvent, but, essentially, not for the solute;
at least one outlet portion of the container affixed with at least one outlet semi-permeable membrane, said outlet semi-permeable membrane having a higher affinity for said solvent and equal or lesser affinity for the solute than said inlet semi-permeable membrane;
said inlet semi-permeable membrane having essentially an inside face and an outside face, its inside face being in contact, inside the solution container, with the solution contained therein, and its outside face in contact with a solvent source containing essentially no solute;
said outlet semi-permeable membrane having essentially, an inside face and an outside face, the inside face being in contact on one side with the solution in the solution container, and so situated that the solvent from the solution in the solution container will tend to be compelled by gravity and/or diffusion and/or osmotic pressure, through said outlet semi-permeable membrane, out of the solution container; and
a means of drawing energy from the fluid flow so generated.

2. A machine as in claim 1, wherein the solvent flowing into, through, and out of the solution container is drawn from and returns to the same solvent source.

3. A machine as in claims 1 or 2, wherein interior of the solution container is in communication, other than through the inlet or outlet semi-permeable membranes, with the ambient atmosphere over its solvent source.

4. A machine as in claims 1 or 2, wherein the solution container is closed off and sealed against communication with the ambient atmosphere that exists over its solvent source except what communication may occur through the semi-permeable membranes.

5. A machine as in claims 1 or 2, wherein the means of extracting energy is a turbine inside to the solution container.

6. A machine as in claims 1 or 2, wherein the means of extricating energy from the generated fluid flow is a turbine or paddlewheel, external to the solution container.

7. A machine as in claims 1 or 2, wherein an agitating device is mounted inside the solution container.

8. A method if generating and extracting energy from sources that include properties of diffusion and osmosis, comprising:
(a) providing a solution container containing solvent and solute and having;
(1) an inlet portion of the container affixed with an inlet semi-permeable membrane,
(2) an outlet portion of the container affixed with an outlet semi-permeable membrane, said membrane having a higher affinity for water than said inlet semi-permeable membrane,
(3) the inlet semi-permeable membrane being in contact on one side with the solution contained by the solution container, and in contact on its other side with a solvent source containing essentially no solute,
(4) the outlet semi-permeable membrane being in contact on one side with the solution contained in the solution container, and so situated that the solvent from the solution in the solution container will tend to be drawn by gravity and/or osmotic pressure through said outlet semi-permeable membrane, out of the solution container, and
(5) a means of drawing energy from the fluid flow so generated.

9. A method as in claim 8, wherein the solvent flowing out of the solution container is drawn from and returns to the same solvent source from which it was drawn.

10. A method as in claims 8 or 9, wherein the solution container is exposed, other than through the inlet or outlet semi-permeable membranes, to the ambient atmosphere over its solvent source.

11. A method as in claims 8 or 9, wherein the solution container is closed off from the ambient atmosphere over its solvent source except as through the semi-permeable membranes.

12. A method as in claim 8 wherein the means of extracting energy is a turbine internal to the solution container.

13. A method as in claims 8 or 9, wherein the means of extricating energy from the generated fluid flow is a turbine or paddlewheel, external to the solution container.

14. A machine as in claims 8 or 9, wherein an agitating device is mounted inside the solution container.

15. A machine as in claim 1 or a method as in claim 8 wherein the solvent source comprises a discrete and essentially finite receptacle or sump of measurable or known volume.
